(19) United States
(12) Patent Application Publication
(10) Pub. No.: US 2010/0280189 A1
(43) Pub. Date: Nov. 4, 2010

(54) SYNTHESIS OF CYCLOALIPHATIC SUBSTITUTED SILANE MONOMERS AND POLYSILOXANES FOR PHOTO-CURING

(75) Inventors: David P. Dworak, Akron, OH (US); Mark D. Soucek, Akron, OH (US)

Correspondence Address: Joseph J. Crimaldi;Roetzel & Andress, 222 S. Main St., Akron, OH, 44308, US

(73) Assignee: THE UNIVERSITY OF AKRON, Akron, OH (US)

(21) Appl. No.: 12/095,567

(22) PCT Filed: Nov. 30, 2006
(86) PCT No.: PCT/US2006/046003

§ 371 Date: Jul. 15, 2010

Related U.S. Application Data
(60) Provisional application No. 60/740,774, filed on Nov. 30, 2005.

(51) Int. Cl. C08G 77/38; C08G 77/04

(52) U.S. Cl. 525/476; 528/40

(57) ABSTRACT

The present invention generally relates to compositions including linear cycloaliphatic siloxane polymers, and the cyclic cycloaliphatic siloxane oligomers from which they are made. The present invention also generally relates to methods for making cycloaliphatic siloxane polymers, and the cyclic cycloaliphatic siloxane oligomers from which they are made. Some embodiments relate to cationic polymerization of methyl, cyclopentyl, and/or cyclohexyl substituted polysiloxanes. In some embodiments the cationic polymerization is a cationic ring-opening polymerization.

### RELATED APPLICATION DATA

This application claims priority to U.S. Provisional Patent Application 60/740,774, filed Nov. 30, 2005, which is hereby incorporated herein by reference in its entirety.

### FIELD OF THE INVENTION

The present invention relates to methods to prepare cationically polymerizable methyl, cyclopentyl, and cyclohexyl substituted polysiloxanes, and to polysiloxanes prepared by such methods.

### BACKGROUND OF THE INVENTION

Polysiloxanes possess a variety of applications, both medical and non-medical. Polysiloxanes and silsesquioxanes have been functionalized with various reactive (vinyl ethers, epoxy groups and non-reactive groups (1-octene, substituted phenyl groups) in order to achieve the desired property or properties. Exemplary applications of siloxanes include high-performance elastomers, membranes, electrical insulators, water repellants, anti-foaming agents, mold release agents, adhesives, and protective films. Furthermore, the ability to synthesize monomers that show an increased glass transition temperature and that can be copolymerized with other polymers such as polyurethanes, polyimides, or other silicone monomer, is desirable. As such, a need exists in the art for improved methods of polysiloxane synthesis and for methods that permit the synthesis of polysiloxanes that have certain desirable chemical and/or physical properties.

### SUMMARY OF THE INVENTION

A synthetic scheme is disclosed for preparing cationically polymerizable methyl, cyclopentyl, and cyclohexyl substituted polysiloxanes. Initially, a suitable cycloalkene and dichlorosilane are reacted at a high pressure (e.g., approximately 250 psi) and high temperature (e.g., approximately 120° C.) to yield the desired cycloaliphatic dichlorosilane. The chlorosilane monomers undergo oligomerization to produce cyclic oligomers of low molecular weight (approximately 2,000 g/mol). Polysiloxanes are then produced through the acid catalyzed ring opening polymerization of the cyclic oligomers, thereby yielding high molecular weight polysiloxanes (approximately 45,000 g/mol). The polysiloxanes can then be functionalized with, for example, cycloaliphatic epoxy and alkoxy silane groups via hydrosilation.

In one embodiment, the present invention relates to a polysiloxane composition comprising: a cyclic compound according to the following formula:

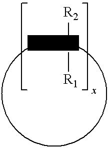

wherein x is an integer from 3 to 20, and R₁ and R₂ are independently selected from hydrogen, methyl, cyclopentyl, or cyclohexyl.

In another embodiment, the present invention relates to a polysiloxane composition comprising: a linear compound according to the following formula:

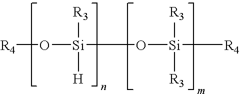

wherein the ratio of the n repeating units to m repeating units is from 1:1 to 1:64, and wherein each R₃ is independently selected from hydrogen, methyl, cyclopentyl, or cyclohexyl and each R₄ is independently selected from hydrogen and a cycloaliphatic epoxide.

In still another embodiment, the present invention relates to a process for synthesizing a cyclic polysiloxane composition comprising the steps of: (i) providing an effective amount of an aqueous base; (ii) reacting a defined amount of cycloaliphatic dichlorosilane in the presence of the aqueous base; and (iii) recovering the polysiloxane product.

In still yet another embodiment, the present invention relates to a process for synthesizing linear polysiloxane comprising the steps of: (a) providing a cyclic compound A comprising the following formula:

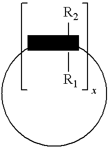

(b) providing a cyclic compound B comprising the following formula:

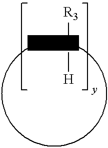

wherein R₁, R₂, and R₃ are independently selected from methyl, cyclopentyl, or cyclohexyl, and wherein x and y are independently integers from 3 to 20; (c) combining cyclic compound A and cyclic compound B in the presence of an ion exchange resin; (d) reacting cyclic compound A and cyclic compound B to form a linear compound according to the following formula:

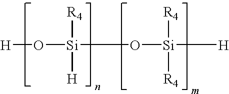

wherein each R₄ is independently selected from hydrogen, methyl, cyclohexyl or cyclopentyl; and (e) recovering the linear compound.

### BRIEF DESCRIPTION OF THE DRAWINGS

FIG. 1 illustrates a reaction scheme, according to one embodiment of the present invention, for synthesizing a cycloaliphatic epoxide/alkoxy silane functionalized poly(dimethylsiloxane-co-methylhydrosiloxane);

FIG. 2 illustrates a reaction scheme, according to one embodiment of the present invention, for synthesizing a hydride functionalized poly(dicycloaliphatic-siloxane-co-cycloaliphatichydrosiloxane);

FIG. 3 is an FT-IR spectrum of hydride terminated poly(dimethylsiloxane-co-methylhydrosiloxane);

FIG. 4 is a proton NMR of hydride terminated poly(dimethylsiloxane-co-methylhydrosiloxane);

FIG. 5 is a silicon NMR of hydride terminated poly(dimethylsiloxane-co-methylhydrosiloxane);

FIG. 6 is an FT-IR spectrum of cycloaliphatic epoxide/alkoxy silane functionalization of a hydride terminated poly(dimethylsiloxane-co-methylhydrosiloxane);

FIG. 7 is a proton NMR spectrum of cycloaliphatic epoxide/alkoxy silane functionalization of a hydride terminated poly(dimethylsiloxane-co-methylhydrosiloxane);

FIG. 8A is an FT-IR spectrum of cyclopentyldichlorosilane;

FIG. 8B is an FT-IR spectrum of cyclohexyldichlorosilane;

FIG. 9A is a proton NMR spectrum of cyclopentyldichlorosilane;

FIG. 9B is a proton NMR spectrum of cyclohexyldichlorosilane;

FIG. 10 is a silicon NMR spectrum of dicyclopentyldichlorosilane reaction before distillation;

FIG. 11A is a silicon NMR spectrum of cyclopentyldichlorosilane;

FIG. 11B is a silicon NMR spectrum of cyclohexyldichlorosilane;

FIG. 12A is a mass spectroscopy analysis of cyclopentyldichlorosilane;

FIG. 12B is a mass spectroscopy analysis of cyclohexyldichlorosilane;

FIG. 13A is an FT-IR spectrum of cyclic oligomers of polycyclopentyl-hydrosiloxane;

FIG. 13B is an FT-IR spectrum of cyclic oligomers of polycyclohexyl-hydrosiloxane;

FIG. 14A is a proton NMR spectrum of cyclic oligomers of polycyclopentyl-hydrosiloxane;

FIG. 14B is a proton NMR spectrum of cyclic oligomers of polycyclohexyl-hydrosiloxane;

FIG. 15A is a silicon NMR spectrum of cyclic oligomers of polycyclopentyl-hydrosiloxane;

FIG. 15B is a silicon NMR spectrum of cyclic oligomers of polycyclohexyl-hydrosiloxane;

FIG. 16A is a proton NMR spectrum of cyclic oligomers of polydicyclopentyl-siloxane;

FIG. 16B is a proton NMR spectrum of cyclic oligomers of polydicyclohexyl-siloxane;

FIG. 17 is an exotherm of the cationic polymerization of Formula 1 at 25° C. for 15 seconds; and

FIG. 18 is an overlay of a T_{g} analysis of cured coatings with 3% photo-initiator.

### DETAILED DESCRIPTION OF THE INVENTION

The present invention relates to methods to prepare cationically polymerizable methyl, cyclopentyl, and cyclohexyl substituted polysiloxanes, and to polysiloxanes prepared by such methods.

In one embodiment, the present invention relates to a synthetic scheme for preparing cationically polymerizable methyl, cyclopentyl, and cyclohexyl substituted polysiloxanes. Initially, a suitable cycloalkene and dichlorosilane are reacted at a high pressure (e.g., approximately 250 psi) and high temperature (e.g., approximately 120° C.) to yield the desired cycloaliphatic dichlorosilane. The chlorosilane monomers undergo oligomerization to produce cyclic oligomers of low molecular weight (approximately 2,000 g/mol). Polysiloxanes are then produced through the acid catalyzed ring opening polymerization of the cyclic oligomers, thereby yielding high molecular weight polysiloxanes (approximately 45,000 g/mol). The polysiloxanes can then be functionalized with, for example, cycloaliphatic epoxy and alkoxy silane groups via hydrosilation.

Chlorosilanes are the basic building blocks of silicones and polysiloxanes. Chlorosilanes are utilized in hydrosilation where the addition of a Si—H compound to a multiple bond, often an alkene or alkyne, is the pathway to synthesize a variety of unique polysiloxane systems. Typically, platinum complexes are used as hydrosilation catalysts due to activity at relatively low concentrations. The most common platinum catalyst is chloroplatinic acid (Speier's catalyst) which is reduced to a platinum (0) species in the presence of a silane or siloxane. During these reactions an induction period is observed, but this can be reduced by using a platinum (0) complex such as Karstedt's catalyst. Other metal based catalysts can be used such as the rhodium based Wilkinson's catalyst, although higher catalyst concentrations are usually required for efficiency.

Processes that involve synthesis of linear siloxane polymers can be divided into two general classifications according to the pathway in which the polymer chain is formed: polymerization of difunctional silanes and ring-opening polymerization of cyclic oligosiloxanes. Hydrolytic polymerization involves the polymerization of halosilanes (mainly chlorosilanes) through the incorporation of water and is often employed for the synthesis of both linear siloxane polymers and cyclic siloxane oligomers; the latter of which can be used further as substrates in ring-opening polymerization. A polysiloxane chain is most often formed as a result of two types of polymerization: homofunctional polymerization of a difunctional silane such as silanediols or dichlorosilanes; and heterofunctional polymerization involving a silanol and another functional group. A heterofunctional polymerization approach is useful for a hydrolytic polymerization step. As a result, both steps; hydrolysis and polymerization, usually occur simultaneously during the reaction.

The process of ring-opening polymerization allows greater control over molecular weight, thus it is often a preferred method for synthesis of high polymers. It can be performed via either anionic or cationic routes, and may be classified either as thermodynamically or kinetically controlled. Most polymerizations are thermodynamically driven; the siloxane bonds being identical in number and kind both in a chain and in a ring, the net energy change is very small. The increase in entropy that complements the increased molecular freedom of the siloxane segments on going from the cyclic structures to the linear chains drives the polymerization reaction. The molecular weight of the polymer at equilibrium during cyclosiloxane polymerizations is controlled by incorporating an end-group, which ensures the closure of the chain with a neutral, non-reactive group.

As is noted above, polysiloxanes possess a variety of applications, both medical and non-medical. Polysiloxanes and silsesquioxanes have been functionalized with various reactive (vinyl ethers, epoxy) groups and non-reactive groups (1-octene, substituted phenyl groups) in order to achieve the desired property or properties. Exemplary applications of siloxanes include high-performance elastomers, membranes, electrical insulators, water repellants, anti-foaming agents, mold release agents, adhesives, and protective films. Furthermore, the ability to synthesize monomers that show an increased glass transition temperature, and that can be copolymerized with other polymers such as polyurethanes, polyimides, or other silicone monomer, is desirable. As such, a need exists in the art for improved methods of polysiloxane synthesis and for methods that permit the synthesis of polysiloxanes that have certain desirable chemical and/or physical properties.

In one embodiment of the present invention, poly(dimethylsiloxane-co-methylhydrosiloxane) (Formula 1) is functionalized with cycloaliphatic epoxides and alkoxy silanes via hydrosilation chemistry.

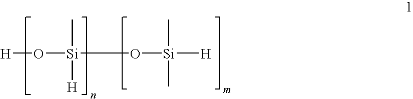

As used throughout the specification and claims m and n represent the number of repeating units in various chemical formulas. In one embodiment, m is equal to an integer from 1 to about 1,500, or from about 10 to about 1,000, or from about 15 to about 500, or from about 20 to about 300, or even from about 20 to about 250. In one embodiment, n is equal to an integer from 1 to about 1,500, or from about 10 to about 1,000, or from about 15 to about 500, or from about 20 to about 300, or even from about 20 to about 250. In another embodiment, the ratio of n to m can vary from about 1:1, about 1:2, about 1:3, about 1:4, about 1:8, about 1:16, about 1:24, about 1:32, or even about 1:64. Here, as well as elsewhere in the specification and claims, individual range limits may be combined to form additional ranges.

In another embodiment of the present invention, the synthesis and functionalization of hydride terminated poly(dicyclopentylsiloxane-co-cyclopentylhydrosiloxane) (Formula 2) and hydride terminated poly(dicyclohexylsiloxane-co-cyclohexylhydrosiloxane) (Formula 3) are performed. The synthetic route for the cycloaliphatic substituted differs from that of methyl substituted in that the cyclic species needs to be synthesized via hydrolytic polymerization of cycloaliphatic substituted silanes. The monomers are then characterized using ¹H NMR, ²⁹Si NMR, FT-IR, and mass spectroscopy. From the monomers, oligomers, and polysiloxanes homopolymers can be prepared. The synthesis of these monomers makes it possible to examine the unique properties that large bulky pendant groups can impart on high molecular weight polysiloxane chains and to explore the various applications for these polymers.

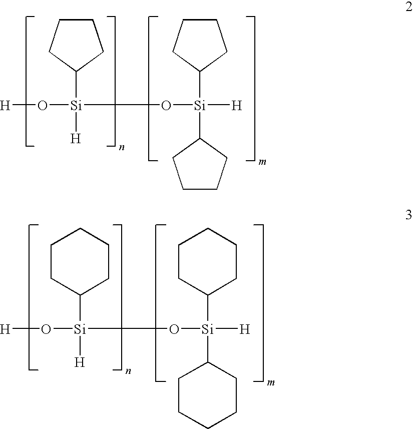

### EXPERIMENTAL

### (1) Materials

Octamethylcyclotetrasiloxane, 1,3,5,7-tetramethylcyclotetrasiloxane, 1,1,3,3-tetramethyldisiloxane, dichlorosilane, and vinyl triethoxysilane are purchased from Gelest, Inc. and used as supplied. Wilkinson's catalyst (chlorotris(triphenylphosphine)rhodium(I), 99.99%), Karstedt's catalyst (platinum(0)-1,3-divinyl-1,1,3,3-tetramethyldisiloxane complex, 3% w/w solution in xylenes), cyclopentene, cyclohexene, Amberlyst 15 ion-exchange resin, and 4-vinyl-1-cyclohexene 1,2-epoxide are purchased from Aldrich and used as supplied.

Toluene, supplied by Aldrich Chemical Co., is distilled in order to eliminate any impurities. Irgacure 250, supplied by Ciba Specialty Chemicals, is used as received. Air sensitive materials are transferred and weighed in a dry box under argon.

### (2) Instruments

Proton NMR spectra are obtained from a Gemini-300 spectrometer (Varian), while silicon NMR spectra are recorded on a Gemini-400 spectrometer (Varian). All NMR samples are prepared in CDCl₃ and recorded at 20° C. Chemical shifts are given relative to a TMS internal standard. FT-IR spectra are obtained on a Mattson Genesis Series FTIR and a Waters system is used for GPC analysis. Mass spectroscopy is performed on a Saturn 2200 (Varian) in El mode with an ion trap read out.

### (3) Functional Group Analysis

The Si—H bond is polarized depending to some degree on the substituents of the silicon. The reactivity of the Si—H bond makes it possible to analyze this group with qualitative or quantitative chemical tests. The Si—H is titrated via the reduction of a mercury (II) salt, as is shown below in Reaction (1).

—Si—H+2HgCl₂→—Si—Cl+Hg₂Cl₂+HCl (1)

The Si—H can be titrated with a base to find the % Si—H in a given sample.

A mercuric chloride solution (4% w/v in 1:1 chloroform-methanol) is pipetted (20 mL) into an Erlenmeyer flask. The sample to be titrated is added and agitated before adding a calcium chloride solution (15 mL, saturated solution in methanol). Phenolphthalein indicator is added (15 drops) after 5 to 6 minutes and the solution is titrated with 0.1 N alcoholic potassium hydroxide. Blanks are titrated in the same manner before and after the analysis. The calculation for % H is shown in the equation below:

%H=[(V₁−V₂)](N_{KOH})(1.008/2000)(100)/sample wt(g)

where V₁ is the endpoint, V₂ is the averaged blanks, and N is the normality of the basic titrant.

### Photopolymerization Procedure:

On average, 2 to 3 milligrams of sample (polymer and 3% photoinitiator w/w) is placed in an uncovered, hermetic, aluminum DSC pan. An empty pan is used as a reference. The chamber of the DSC is purged with nitrogen before the polymerization and the purge continues throughout the reaction. The samples are photocured with UV light (150 mW/cm²) for various exposure times (1, 5, and 15 seconds) and temperatures (−10, 25, and 60° C.). The heat flux, as a function of reaction time, is monitored under isothermal conditions, and the rate of polymerization is calculated. The heat of reaction (ΔH_{R}) used for the epoxy group is 23.13 kcal/mol.

The rate of propagation (Rₚ) is directly proportional to the rate at which heat is released from the reaction. As a result, the height of the DSC exotherm can be used in conjunction with other sample information to quantify the rate of polymerization. The rate formula used in the analysis of the photopolymerization data is shown below:

Rₚ=((Q/s)·M)/(n·ΔH_{R}·m)

where (Q/s) is the heat flow per second released during the reaction in J/s, M is the molar mass of the reacting species, n is the average number of epoxy groups per polymer chain, and m is the mass of the sample.

### Synthesis of Hydride Terminated Poly(dimethylsiloxane-co-methylhydrosiloxane)

In a three neck round bottom flask, equipped with a reflux condenser and nitrogen inlet/outlet, is added octamethylcyclotetrasiloxane (90.00 grams, 0.30 mol), 1,3,5,7-tetramethylcyclotetrasiloxane (5.33 grams, 22.1 mmol), 1,1,3,3-tetramethyldisiloxane (0.67 grams, 5.3 mmol), and Amberlyst 15 (20 wt %). The contents are then stirred at 70° C., under nitrogen, for 15 hours. The viscous solution is then filtered to obtain hydride terminated poly(dimethylsiloxane-co-methylhydrosiloxane) (Formula 1) of various molecular weight ranges. Vacuum filtration is performed (<1 mm Hg) in order to remove low molecular weight oligomers and the unreacted starting materials. Weight average molecular weight is obtained from gel-permeation chromatography (GPC) analysis (results: Mₙ=45,000, PDI=1.66). Polymer characterization and Si—H functionality is confirmed/analyzed through ²⁹Si NMR, ¹H NMR, FT-IR analysis, and titration. The polysiloxanes of Formulas 2 and 3 are produced in the same manner.

### Synthesis of Cycloaliphatic Dichlorosilane

A dry, sealed, and evacuated stainless steel bomb, cooled via a dry ice/acetone bath, is charged with chilled cycloalkene (5 grams, approximately 30 mmol) and Wilkinson's catalyst (0.15 grams, 0.16 mmol) and purged with nitrogen. In a chilled (<−10° C.), calibrated tube, dichlorosilane (5 mL, 0.06 mol) is condensed and then distilled into the bomb through the inlet valve via a cannula. The inlet valve is sealed and the bomb is then allowed to warm to room temperature. The bomb is then heated for 24 hours at 120° C. by means of an oil bath. The bomb is then allowed to cool. The reaction produced a clear, light yellow liquid. After distillation, any unreacted cycloalkene and side products are removed via vacuum (2-3 mm Hg) to yield pure cycloaliphatic dichlorosilane (approximate yield: 88%). Product characterization is performed by ²⁹Si NMR, ¹H NMR, FT-IR, and mass spectroscopy.

According to one embodiment the cycloaliphatic dichlorosilane defines a ring from 3 to about 20 members, from 3 to about 15 members, from 3 to about 12 members, from 3 to about 10 members, from 3 to about 8 members, from 3 to about 6 members, or even 8 members. Here as elsewhere in the specification and claims, ranges may be combined.

### General Synthesis of Cyclic Oligomers of Polycycloaliphatichydrosiloxane:

To a three neck round bottom flask, equipped with a reflux condenser, nitrogen inlet/outlet, and dropping funnel, is added saturated aqueous sodium bicarbonate (10 mL) and diethyl ether (5 mL). A solution of cycloaliphatic dichlorosilane (4.43 grams, approximately 0.03 mol) in ethyl ether (5 mL) is then added drop wise via the dropping funnel. The solution is stirred for several minutes a room temperature. The ether layer is separated, passed through a filter, and any remaining traces of ether are removed via vacuum distillation (3-5 mm Hg) to yield a clear, viscous oil. Weight average molecular weight is obtained for both the cyclopentyl and cyclohexyl substituted cyclic oligomers from gel permeation chromatography. The polycyclopentylhydrosiloxane oligomers has a Mₙ=1,800 and a PDI=2.44. The polycyclohexylhydrosiloxane oligomers has a Mₙ=2,230 and a PDI=2.53. Oligomer characterization is performed via ²⁹Si NMR, ¹H NMR, FT-IR, and mass spectroscopy.

According to one embodiment the cycloaliphatic dichlorosilane defines a ring from 3 to about 20 members, from 3 to about 15 members, from 3 to about 12 members, from 3 to about 10 members, from 3 to about 8 members, from 3 to about 6 members, or even 8 members. Here, as well as elsewhere in the specification and claims, individual range limits may be combined to form additional ranges.

### Synthesis of Cyclic Oligomers of Polydicycloaliphaticsiloxane

To a single neck round bottom flask equipped with a reflux condenser and nitrogen inlet/outlet, is added cyclic oligomers of the desired polycycloaliphatichydrosiloxane (5 grams), the preferred cycloalkene (15 grams), and Karstedt's catalyst (0.1 mL, 0.22 mmol). The reaction is held at 110° C. in an oil bath and magnetically stirred. The disappearance of the Si—H functionality is monitored through FT-IR and the disappearance of the peak at approximately 2160 cm⁻¹ indicates that the reaction is complete (usually in less than 48 hours). Any unreacted cycloalkenes are removed under vacuum (3-5 mm Hg) to yield a clear, viscous oil. Products are characterized by ²⁹Si NMR, ¹H NMR, FT-IR, and mass spectroscopy.

According to one embodiment the cycloaliphatic dichlorosilane defines a ring from 3 to about 20 members, from 3 to about 15 members, from 3 to about 12 members, from 3 to about 10 members, from 3 to about 8 members, from 3 to about 6 members, or even 8 members. Here, as well as elsewhere in the specification and claims, individual range limits may be combined to form additional ranges.

### Cycloaliphatic Epoxide and Alkoxy Silane Functionalization of Prepared Hydride Terminated Poly(dialkyllsiloxane-co-alkylhydrosiloxane) Polymers:

To a three neck round bottom flask, equipped with a reflux condenser and nitrogen inlet/outlet, is added a suitable amount of the compounds of Formula 1, 2, or 3 (30 g), 4-vinyl-1-cyclohexene diepoxide (20 grams, 0.18 mol), vinyl triethoxysilane (2 grams, 0.01 mol), and Wilkinson's catalyst (0.004 grams, 4.3 μmol). Dry, distilled toluene (30 grams) is added via a cannula. The reaction is held at 75° C. in an oil bath and mechanically stirred under nitrogen. The disappearance of the Si—H functionality is monitored through FT-IR and the disappearance of the peak at approximately 2160 cm⁻¹ indicates that the reaction is complete. Any solvent and unreacted starting materials are removed under vacuum (3-5 mm Hg). Cycloaliphatic epoxide and alkoxy silane functionalization is confirmed/analyzed through ¹H NMR, FT-IR analysis, and titration.

### Results and Discussion:

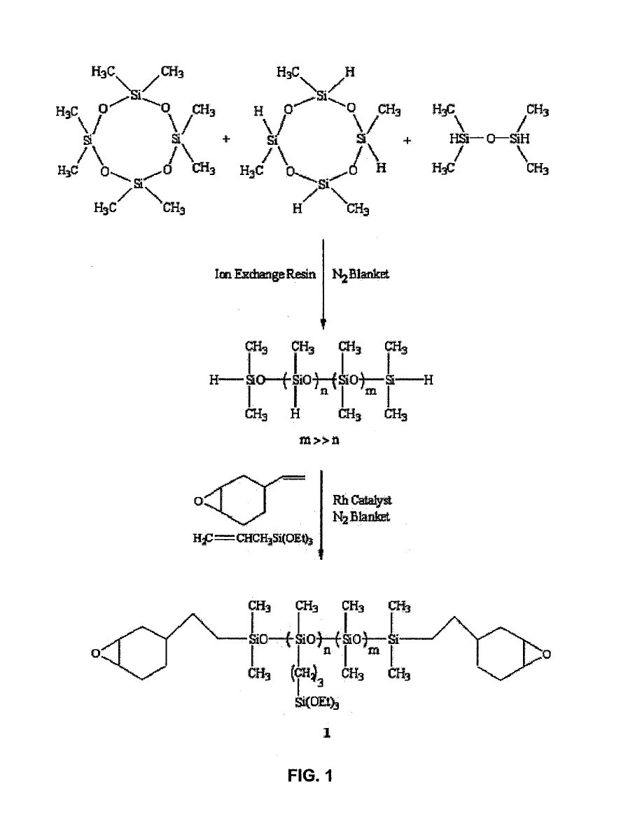

One objective of the present invention, is to prepare a UV-curable polysiloxane with cyclopentyl and cyclohexyl groups. The route used in the preparation of the cycloaliphatic substitution is utilized due the difficulties reacting the internal alkene with the available silane group. The initial hydrosilation between dichlorosilane and the cycloalkene is performed in order to control the amount of silane functionality along the polysiloxane backbone. The reaction of the mono- and disubstituted cycloaliphatic substituted cyclic oligomers is similar to that of the methyl substituted polysiloxane (FIG. 1). The control over the ratio of mono- and disubstituted cyclic oligomers allows management over the silane functionality present along the polymer backbone. In these experiments, all mono- and disubstituted cyclic oligomer ratios were 1:18. However, this ratio can vary from about 1:1, about 1:2, about 1:3, about 1:4, about 1:8, about 1:16, about 1:24, about 1:32, or even about 1:64. Here, as well as elsewhere in the specification and claims, individual range limits may be combined to form additional ranges.

Attempts at the synthesis of the dicycloaliphatic dichlorosilanes proved exceptionally difficult even under extreme pressure (300 psi) and temperatures (250° C.). Hydrosilation accelerators, such as benzaldehyde and acetone, and higher catalyst concentrations can be employed with no considerable results.

### Synthesis and Characterization

A synthesis diagram of the functionalization of hydride terminated poly(dimethylsiloxane-co-methylhydrosiloxane) is presented in FIG. 1. As used in FIG. 1, and as is noted above, m and n represent repeating units in Formulas 1, 2 and 3. In one embodiment, m is equal to an integer from 1 to about 1,500, or from about 10 to about 1,000, or from about 15 to about 500, or from about 20 to about 300, or even from about 20 to about 250. In one embodiment, n is equal to an integer from 1 to about 1,500, or from about 10 to about 1,000, or from about 15 to about 500, or from about 20 to about 300, or even from about 20 to about 250. Here, as well as elsewhere in the specification and claims, individual range limits may be combined to form additional ranges.

The pendant alkoxy silane aids in miscibility during formulation and provides a site for interaction with the metal/silicon-oxo-cluster, while the cycloaliphatic epoxide provides a cross linking site for cationic UV induced cure. The overall structure of Formula 1 will be a block copolymer composed of mostly ‘D’ units (R—Si—R) and the desired functionalities.

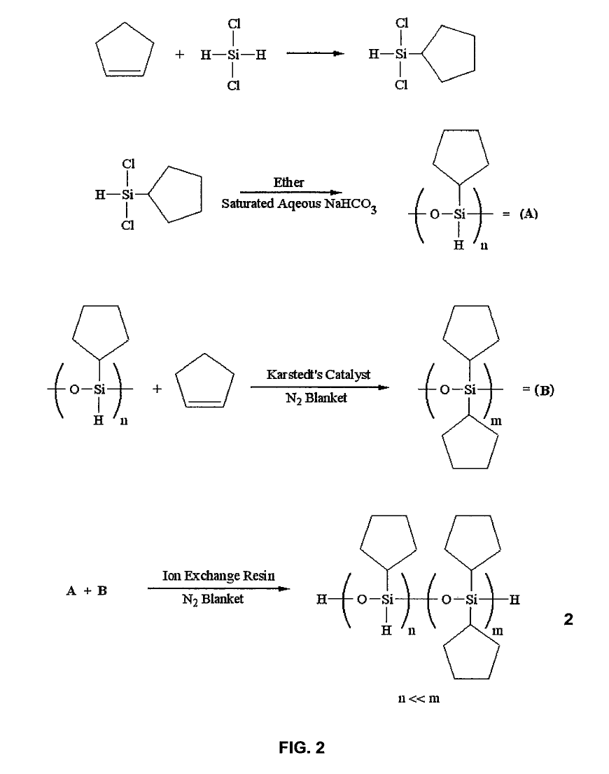

A diagram of the synthesis of Formula 2 is presented in FIG. 2 and functionalization of Formulas 2 and 3 can be performed in the same manner as for Formula 1. The cycloaliphatic substitution along the polysiloxane backbone is chosen as the method for raising the glass transition of the polysiloxane, while not contributing to UV absorption and ultimately to yellowing.

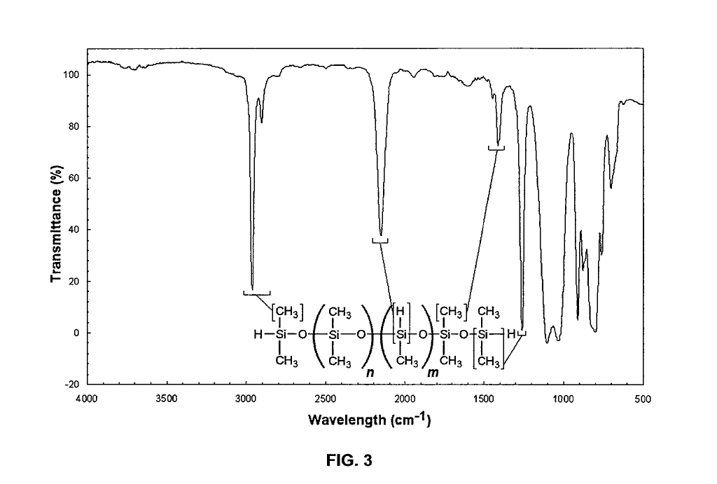

The synthesis of Formula 1 is verified through FT-IR (see FIG. 3) and shows that the Si—H functionality is present due to the strong peak at 2160 cm⁻¹, while the two peaks 1090 and 1110 cm⁻¹ are indicative of high molecular weight polysiloxanes. The indication of cyclic species would be evident in the region of 1000 cm⁻¹ with the band being strong and broad and spanning 50 to 100 cm⁻¹ across. The indication of two bands in this region is strong confirmation of high molecular weight species. However, cyclic species higher than 50 units long can still show similar peaks and present misleading information. As a result, GPC analysis is used to confirm that no traces of cyclic species were present. The GPC chromatogram showed the typical bell curve for high molecular weight polymer; and if cyclic species were present then two more peaks would have eluted before the main peak, which are evidence of cyclic species. The % Si—H analysis for Formula 1 yielded 15.3±0.8%.

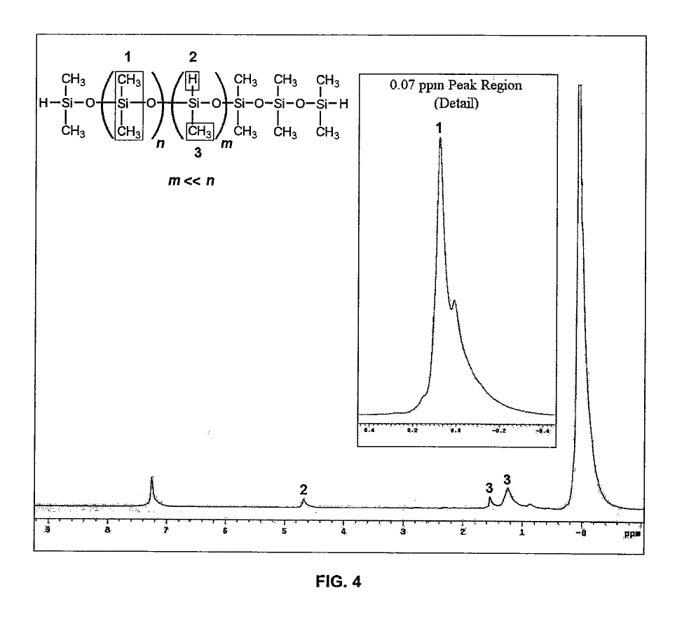

Further analysis via ¹H NMR (see FIG. 4) shows the strong, characteristic peak for Si-Me at δ0.07 ppm and the Si—H functionality at δ4.68 ppm. The peak at δ0.07 ppm is split due to an adjacent Me—Si—H atom. Two smaller peaks were observed at δ1.22 and δ1.57 ppm, which are a result of magnetic inequalities due to the different stereo-configurations of the substituents along the polymer backbone. The magnetic nonequivalence of the CH₃ protons is a result of their different environments due to fact that one methyl group has two other methyl groups as neighbors in the cis-cis position, whereas the others are surrounded by one methyl and one hydrogen in a cis-trans position.

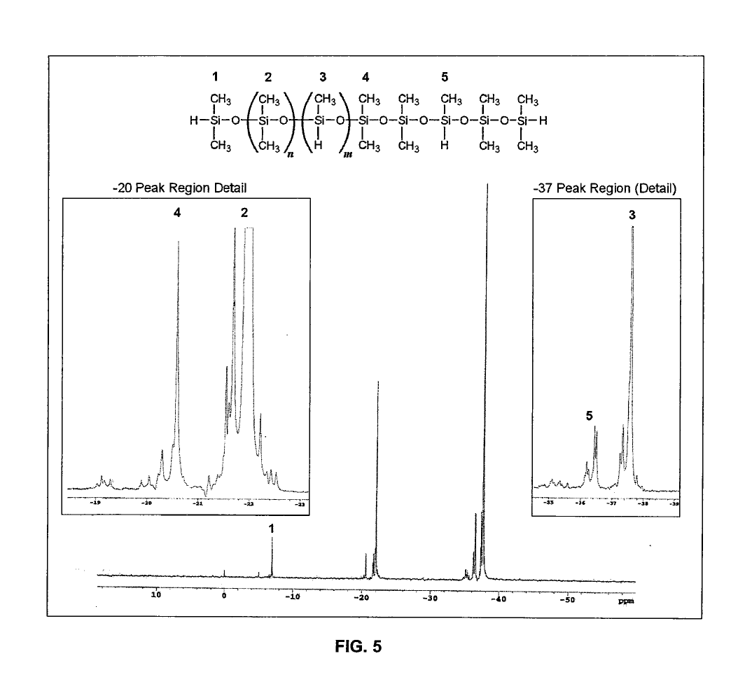

The silicon NMR (J=200) of Formula 1 (see FIG. 5) shows two main groups of signals corresponding to the D and D′ (Me—Si—H) units in the difunctional siloxy unit region. A typical copolymer whose molar ratio is 1:1 and/or that has random units yields more symmetrical peak patterns. However, when the molar ratio is no longer equal (e.g., 14:1 in this case) and/or the copolymer is a blocky microstructure, then the intensities in the NMR patterns deviate from the symmetric case. Furthermore, the observance of a quartet can occur from the non-additivity of the chemical shifts resulting from different arrangements of the neighboring units.

The small downfield peak at approximately δ−8 ppm is representative of a hydrogen substituted ‘M’ (R₃—Si—) unit. Trimethyl substituted M units appear in the δ5-10 ppm region of the spectra, which is further evidence that the polysiloxane chain is hydrogen terminated. When comparing the D unit silicon atoms to an M unit one; the D unit silicon is bonded to an additional oxygen atom. The downfield shift of the M unit occurs due to the lack of an oxygen atom, which de-shields the Si nuclei. The cluster of peaks near δ−21 ppm are representative of various D units. The inset shows peaks between δ−20 and δ−21 ppm, which are representative of D units that are adjacent to a D′ unit. The non-equivalence of the of the silicon atoms causes a slight downfield shift. The peaks at δ−22 ppm symbolize repeating D units in a linear chain. The various peaks are a result of the different molecular weight chains in the sample. The up field peaks at approximately δ−38 ppm are the D′ units within the polysiloxane chain and the same trend with the D units is observed with the D′ units; with the repeating units being slightly up field of the different adjacent silicon atom peaks. In addition, the starting material 1,3,5,7-tetramethylcyclotetrasiloxane has reacted completely due to the fact that it would appear as a peak near δ−32 ppm in the spectrum.

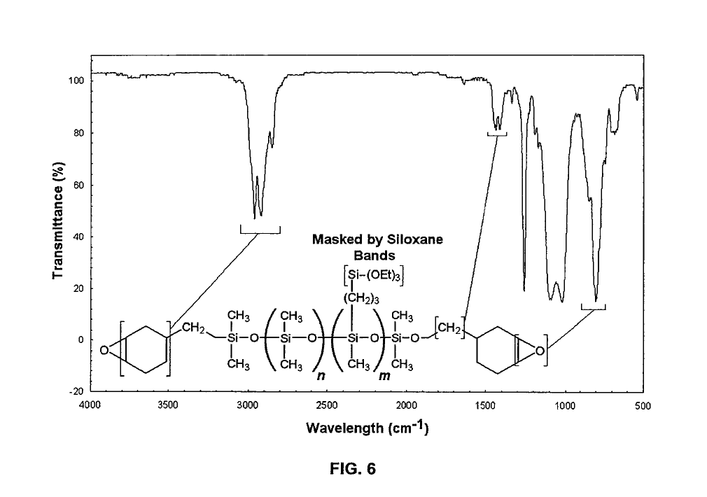

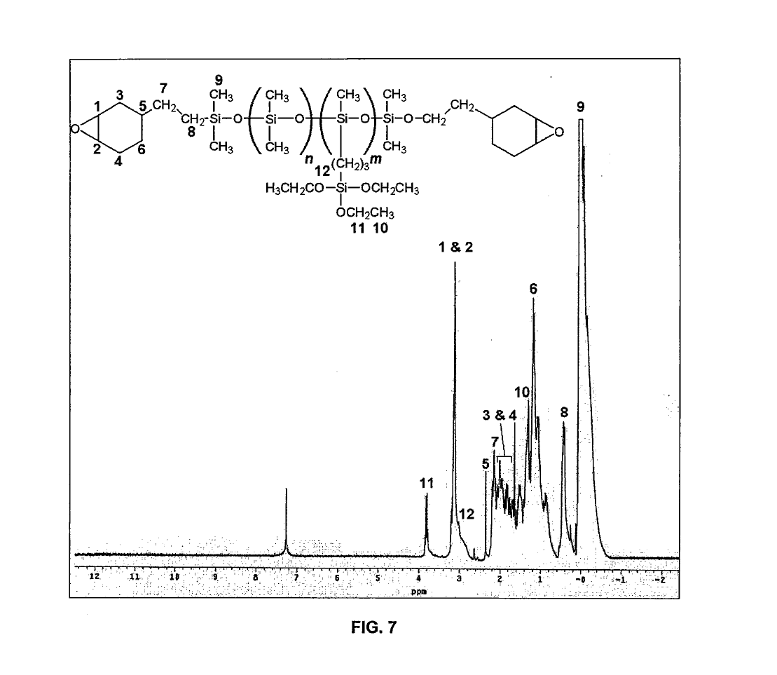

Functionalization of Formula 1 with cycloaliphatic epoxides and alkoxy silanes is analyzed via FT-IR (see FIG. 6) and shows clear evidence of the epoxy ring. However, the Si—O—Si bands at 1000 cm⁻¹ take precedence and mask the alkoxy silane functionality. As a result, proton NMR is used for confirmation of the alkoxy silane functionality (see FIG. 7). The triplet at δ3.8 ppm represents the —CH₂—protons of the alkoxy silane group.

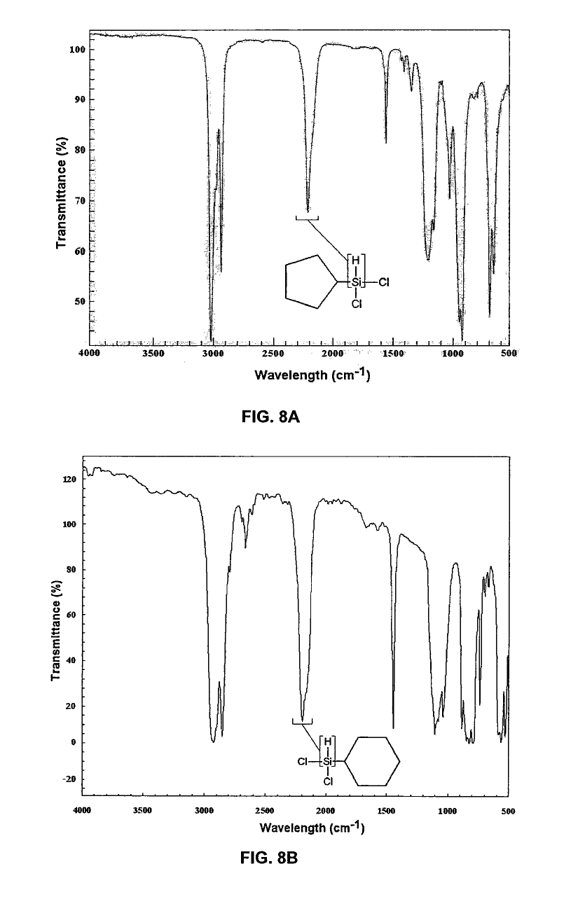

The synthesis of the cycloaliphatic dichlorosilanes is analyzed through FT-IR, proton NMR, and silicon NMR. The FT-IR spectra of the cycloaliphatic dichlorosilanes (see FIG. 8) shows the presence of the Si—H peak at approximately 2200 cm⁻¹ and the existence of the Si—Cl₂ functionality at approximately 500 cm⁻¹. The Si—H transmission peak location can be a good indication of the inductive effects of the other substituents on the silicon atom.

The silane peak position can be predicted accurately if all of the substituents are known. By adding the wavelength values for each of the substituents (—Cl, —Cl, and —C₅H₉/C₆H₁₁) the location the Si—H peak value can be found (see Table 1).

TABLE 1
Calculated and Actual Values of Si—H Transmittance Peaks

| | Calculated | Actual |
|---|---|---|
| Structure | (cm⁻¹) | (cm⁻¹) |
| Cyclopentyldichlorosilane | 2206 | 2202 |
| Cyclohexyldichlorosilane | 2197 | 2200 |

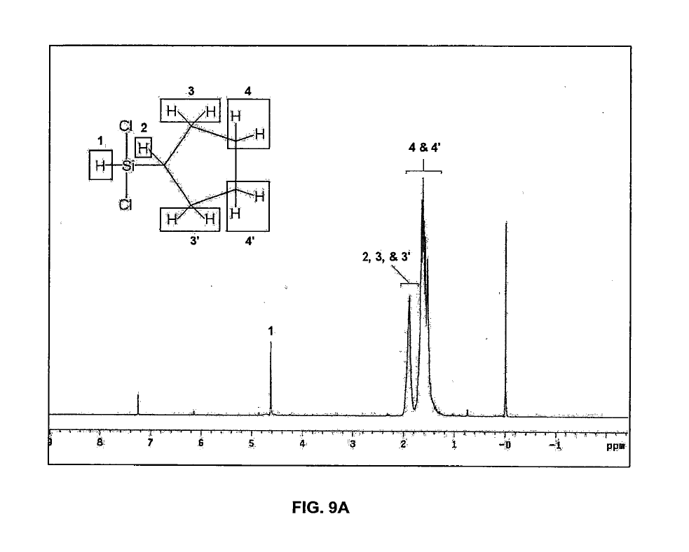

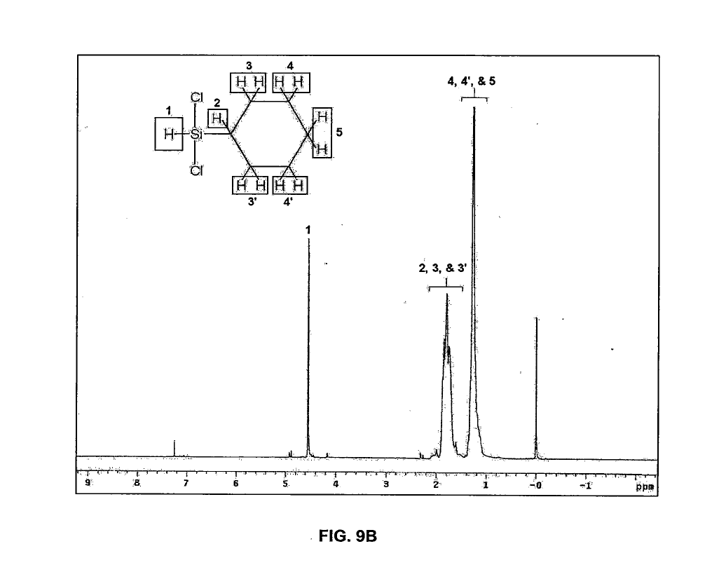

The proton NMR spectra of the cycloaliphatic dichlorosilanes (see FIG. 9) show three distinct peaks. The up field peaks are representative of the cycloaliphatic substituent, while the downfield peak is the Si—H proton. The Si-alkyl groups usually display the expected shift patterns, with the patterns being fairly representative of the substituent due to the shielding effects of the silicon atom. However, this pattern can be affected by the inductive and/or shielding effects of the other substituents on the silicon atom. Closer examination of the Si—H peak reveals a multiplet, which could be the result of the sample reacting with residual water left in the CDCl₃ and producing oligomers of 3 to 6 units long. The presence of the small pair of satellite lines near the main resonance of the Si—H peak is a result of the ²⁹Si isotope. The location of the Si—H peaks between the cyclopentyl and cyclohexyl group differ by approximately δ0.1 ppm, but show that only subtle changes in the substituents can affect the position of the Si—H peak.

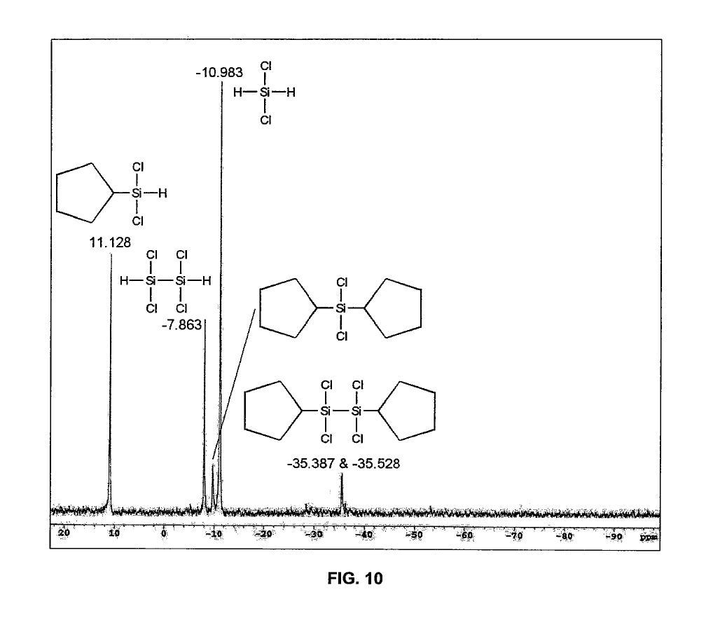

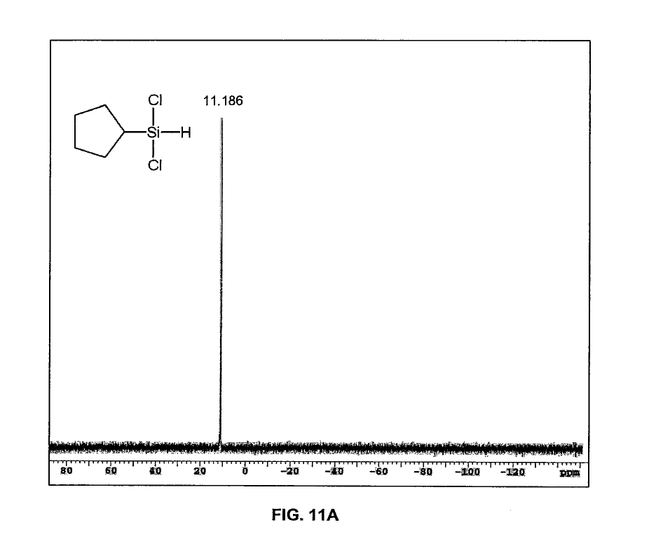

Silicon NMR is also used to analyze the reaction product (see FIG. 10). FIG. 10 shows that several side, products are formed in addition to the desired product. The formation of the disilane compounds (tetrachlorodisilane and dicyclopentyl-tertrachlorosilane) is of particular interest in that the catalyst used is not only selective towards hydrosilation through alkenes, but also can undergo addition reactions to form disilane compounds. Preliminary data shows that bulky substituents tend to hinder the formation of disilane compounds, while smaller groups tend to yield more disilane compounds.

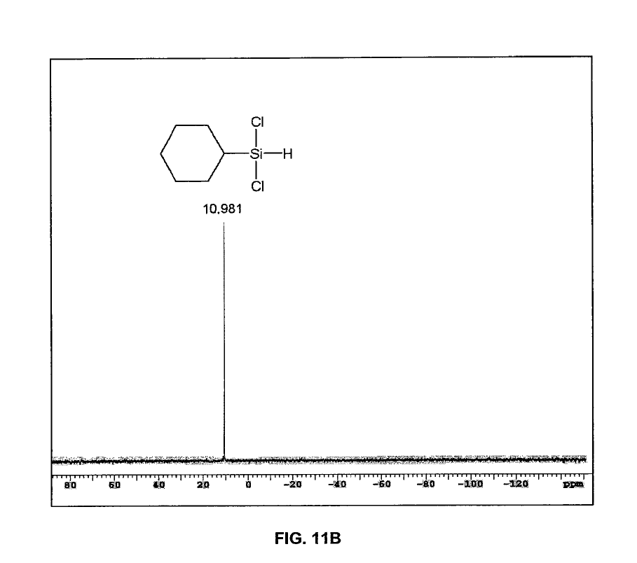

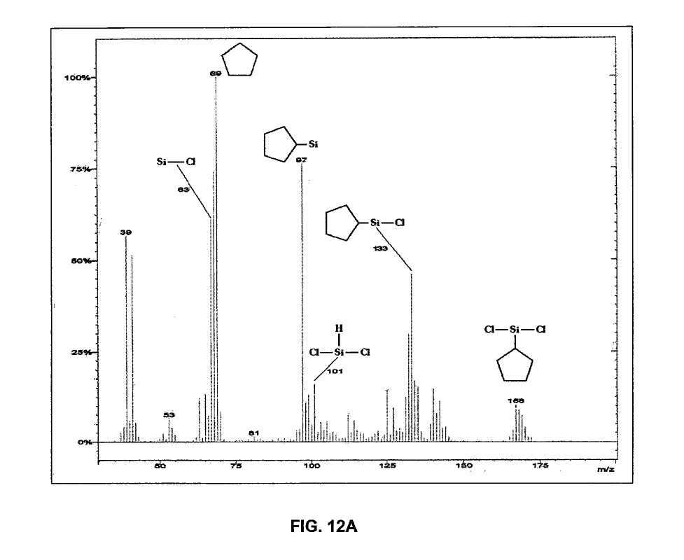

After distillation the silicon NMR (see FIG. 11) reveals the presence of the desired cycloaliphatic substituted silane. The difference between the two peaks is only 0.276 ppm, showing that one less carbon atom has enough de-shielding character to cause an up field shift in the peak signal.

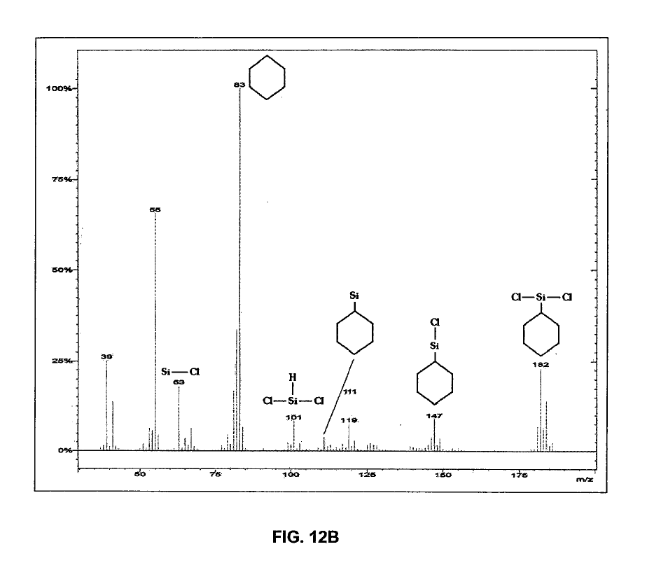

FIG. 12 shows the mass spectra for both cyclopentyldichlorosilane and cyclohexyldichlorosilane, and shows the radical cleavage of each of the four substitutes. For silanes containing the substituents present on the above samples, the larger alkyl substituents tend to cleave first; which is observed due to the abundance of the cycloaliphatic ring in both of the spectra. In addition, when the breakage of the C—C bond becomes less and less probable; as in the case with cyclohydroarbons and short alkyl chains, another process competes. This process is the loss of HCl from the molecular ion, leaving another odd-electron ion. FIG. 12 contains evidence of this loss (m/z 133 for cyclopentyldichlorosilane) and (m/z 147 for cyclohexyldichlorosilane). The presence of the molecular ion, predictable radical cleavages, and a distribution pattern which allows recognizable isotropic peaks makes the interpretation for this class of compounds straightforward.

The acid liberating polymerization of dichlorosilanes is an equilibrium process; the reverse reaction can seriously affect the molecular weight and overall linearity of a polymerized product unless the acid is neutralized from the system. The substituents are usually resistant towards the HCl that is given off as a bi-product, such as dichlorodimethylsilane. However, if a Si—H group is present the HCl released will react with it, as is shown below,

Si—H+HCl→Si—Cl+H₂

and form an undesired Si—Cl, which can undergo hydrolysis and rather than a linear polysiloxane chain a substituted silsesquioxane is formed. Therefore, a saturated aqueous basic solution is used to neutralize the liberated acid.

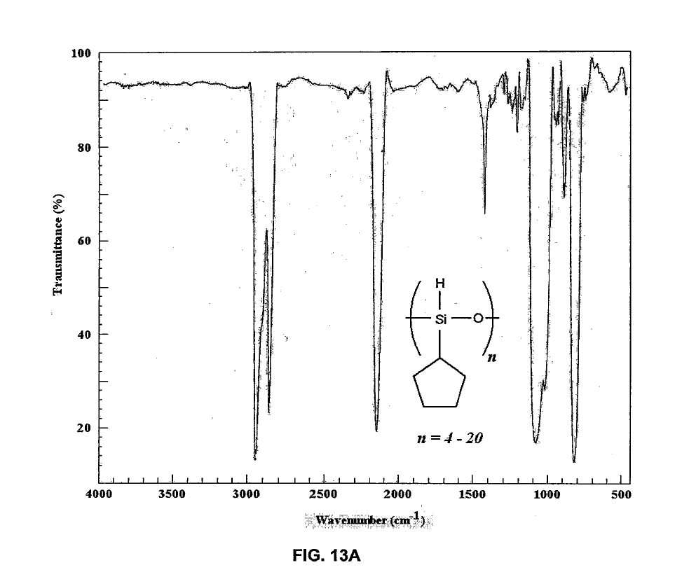

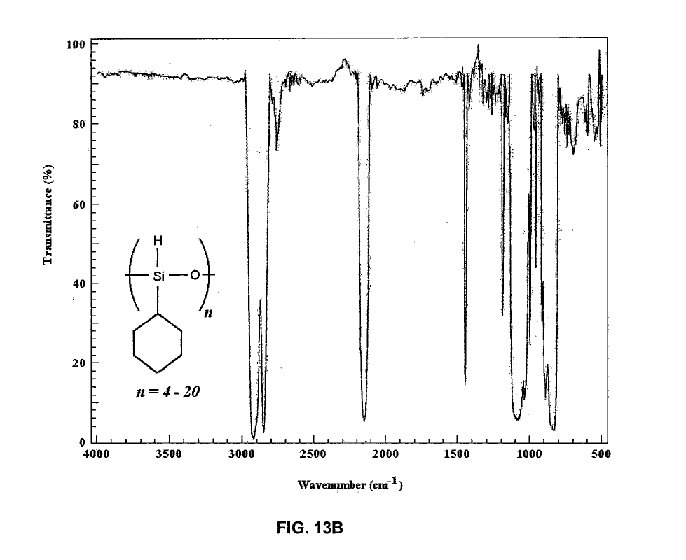

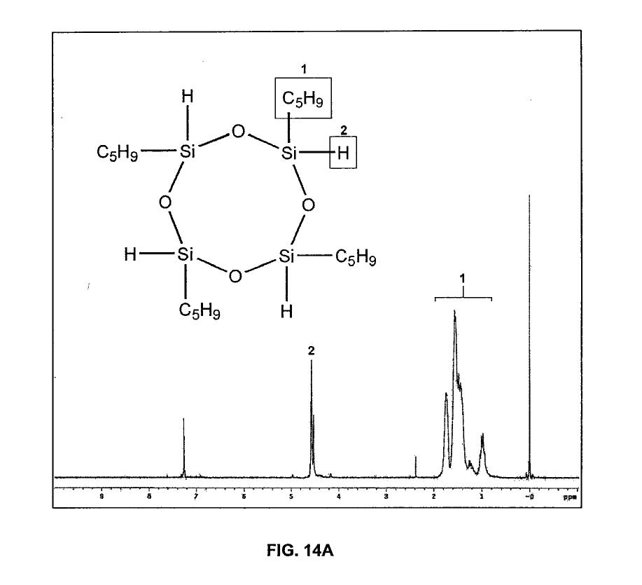

The products of the hydrolytic polymerization of the cycloaliphatic dichlorosilanes are analyzed via FT-IR (see FIG. 13). The strength of the Si—O—Si band indicates that the rings are not of sufficient size (<20) due to the fact that the characteristic anti-symmetric stretch of Si—O—Si at approximately 1100 cm⁻¹ peak is not present; as seen in FIG. 8. What is also important to note is the disappearance of the Cl—Si—Cl peaks near the 500 cm⁻¹ region, indicating that all of the material has reacted into polysiloxane chains. Another interesting note is the non-existent Si—OH peak, typically found near the 3700 cm⁻¹ region. This lack of this peak is evidence that cyclic species are present and that no linear chains terminated with a terminal Si—OH group are produced. Finally, the Si—H peak is still present showing that the HCl produced during the reaction is neutralized by the base and did not affect the functionality.

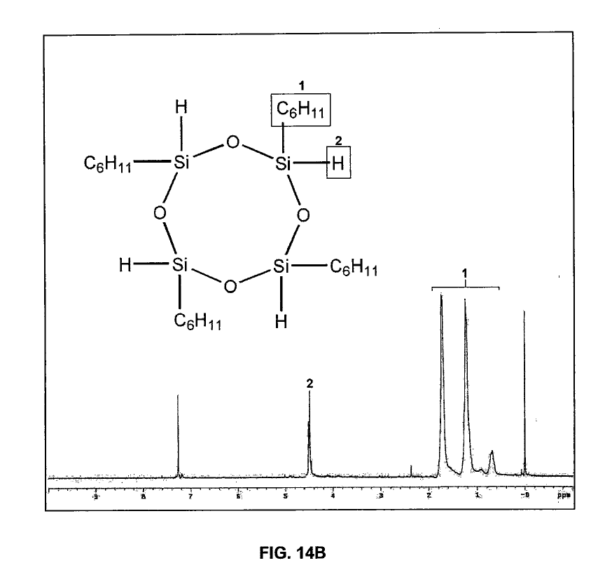

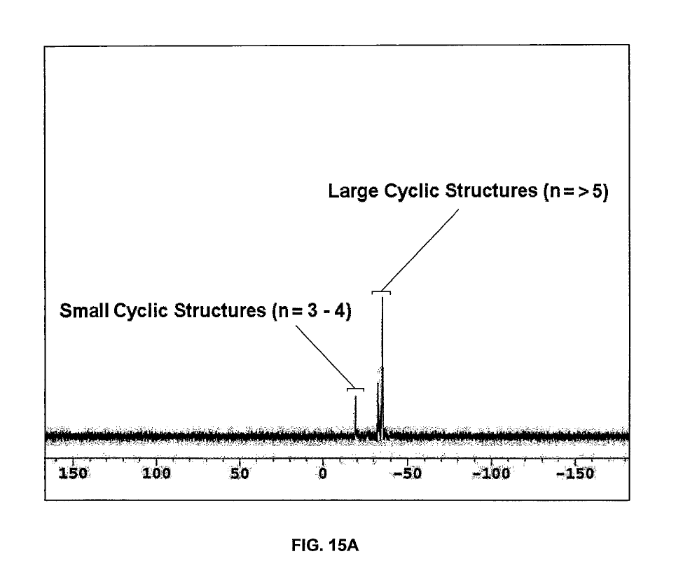

The proton NMR spectra of the cyclic oligomers show the same trend as seen in the NMR spectra of Formula 1 (see FIG. 4). Since the substituents along the polysiloxane chains are atactic, their environments are different, which causes the protons to possess magnetic nonequivalence. When the spectra in FIG. 14 are compared with those in FIG. 9 it is apparent that the cis/trans configurations have a dramatic effect on the NMR spectra. When studying the Si—H proton peak at approximately δ4.5 ppm, it is evident that more than one signal is present and the splitting appears to be more predominant in longer chains. This is, again, due to the atactic configurations of the substituents and the hydrogen atom being either surrounded by two hydrogens, one hydrogen and one cycloaliphatic ring, or two cycloaliphatic rings. The same reasoning is behind the multitude of peaks in the region for the cycloaliphatic protons; however, the effect seems to be more prominent with the Si—H protons.

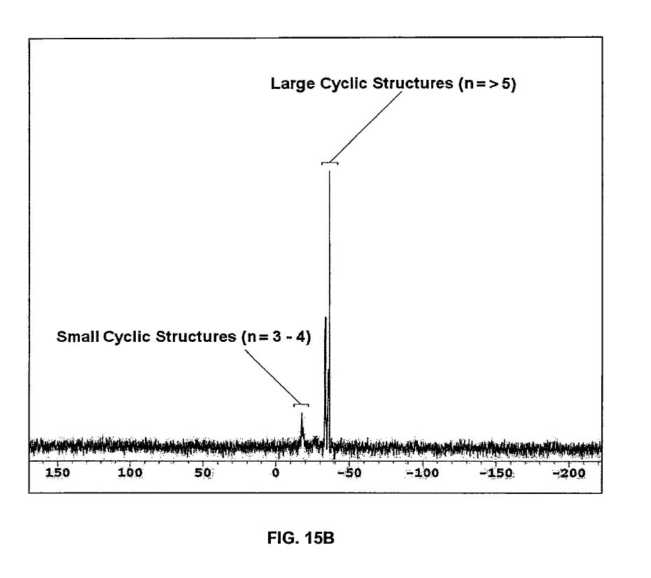

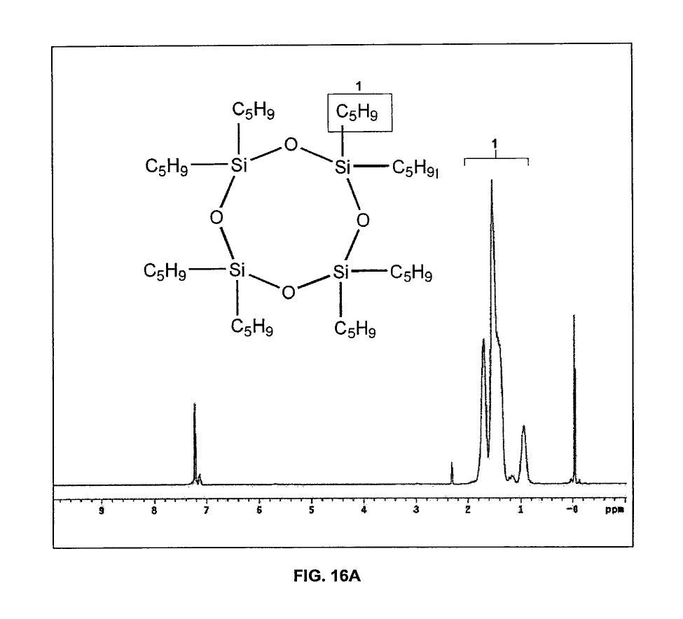

The silicon NMR (J=200) of the cyclic oligomers (see FIG. 15) shows evidence of cyclic species. The downfield peaks represent the cyclic D′ units of the low molecular weight oligomers, while the up field peaks are characteristic of the larger cyclic D′ units. The peaks present at −30 ppm are indicative of R—Si—H siloxane units, while the peaks near δ−20 ppm represent smaller cyclic siloxane structures. The ring strain that the small cyclic siloxanes possess de-shields the ²⁹Si nucleus resulting in shifts to higher frequencies. The multiple peaks, again, come from the number of microenvironments present along the oligomer chain and the various sized cyclic structures. FIG. 15 shows that no Si—OH groups exist and also that all the Si—Cl groups have reacted, which would be the possible end groups on linear chains.

Calculations show that the average size of the cyclic structures is 15 units. The small size of the cyclic chains could be a result of the dilution of the cycloaliphatic dichlorosilanes along with the drop wise method of adding the dissolved silanes into the organic phase. It is interesting to note that both oligomerization reactions, regardless of the substituent, produced approximately 10% of small cyclic species of about 3 to 4 siloxane units.

Matrix assisted laser desorption ionization—time of flight mass measurement is attempted to determine the molecular weight and confirm the repeat units. Obtaining this information from the cyclic oligomers proved difficult in that the bulky cyclic groups shield the oxygen atoms from cation attachment. In addition, cyclic species do not readily ionize as a result of cyclic structure hindering coordination of the large sodium ion. A smaller ion (lithium) is used in the likelihood that it was small enough to coordinate with the oxygen atoms, but this attempt also did not yield appreciable results. Quadrupole—time of flight mass spectroscopy is also attempted, but generated the same noisy data. Various ratios of matrix, cation, and sample were tested with no satisfactory results. The highest molecular weight obtained from GPC is approximately 4,000, which correlates to a ring size of approximately 37 units.

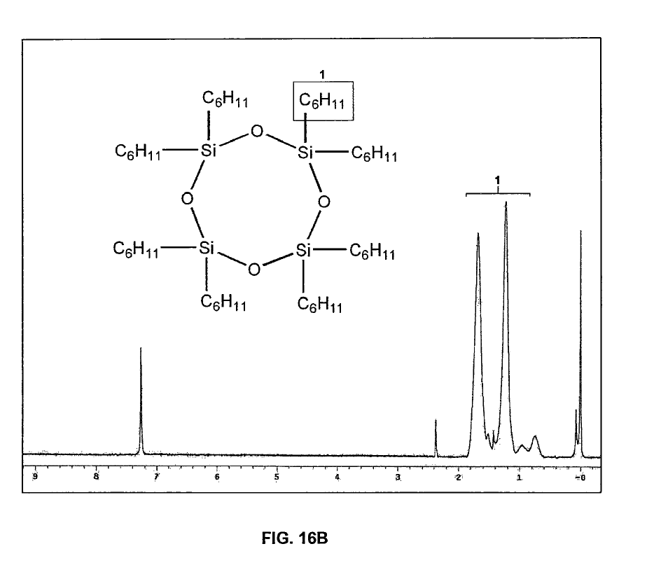

The proton NMR spectra of the results from the hydrosilation of Formulas 2 and 3 with the desired cycloalkene to produce the cyclic oligomers of polydicycloaliphaticsiloxane (see FIG. 16); show the disappearance of the Si—H functionality (approximately δ4.5 ppm) and the strong presence of the cycloaliphatic character. The reaction is sluggish due to the bulky substituents and that the alkene functionality undergoing hydrosilation is an internal alkene as opposed to the faster reacting terminal alkene. The cyclic structure of the polysiloxanes also played a role in the lengthy rate of hydrosilation. The FT-IR spectra also confirmed the disappearance of the Si—H functionality.

Once the cyclic oligomers of the polydicycloaliphaticsiloxanes are prepared they can be combined with the cyclic oligomers of the polycycloaliphatichydrosiloxanes to yield hydride terminated poly(dicycloaliphaticsiloxane-co-cycloaliphatichydrosiloxane) (Formulas 2 and 3). The procedure to produce Formulas 2 and 3 is done in the same matter used to produce Formula 1, which employs an A-15 ion exchange resin and an end capper; which is used to control molecular weight. Without the end capper the chains will terminate by pure chance and will extend the lifetime of the reaction. The % Si—H analysis for Formulas 2 and 3 yield 11.5±1.1% and 10.8±0.9%, respectively. Gel-permeation chromatography shows that both Formulas 2 and 3 had average molecular weights of approximately 35,000 g/mol.

### Photo and Differential Scanning Calorimetry:

Photoinitiated cationic polymerization of functionalized polysiloxanes yields highly crosslinked networks. In addition, it is important to understand the relationship between the polymer structure and reaction conditions with the properties of the networks formed. Photo-differential scanning calorimetry (PDSC) makes it possible to investigate the polymerization behavior, and especially the kinetics of photopolymerization reactions, due to their highly exothermic reaction characteristic upon exposure to UV light. As a result, the reaction rate can be measured by observing the rate at which the heat is released from the sample subject to polymerization. Profiles of reaction heat releases versus time can be utilized to characterize the reaction kinetics The kinetics vary from system to system and are generally complex; therefore, a generalized kinetic expression is not available for cationic polymerizations. This is due to the reactivity of the carbocationic center being heavily dependant on the proximity of the counter-ion.

In addition, a number of propagating species can/may be identified during the polymerization such as ion pairs, solvated ions, and/or aggregates. Finally, the pseudo-steady-state approximation is invalid for these types of polymerizations due to the active centers not undergoing combination; as seen in free radical polymerizations. As a result, the rates of initiation and termination are not equal; which require non-steady state analysis. The understanding of the kinetics of cationic polymerizations is valuable due to the increasing demand for fast curing, low VOC films. The PDSC profiles obtained present significant information about the curing kinetics of cationic photopolymerizations.

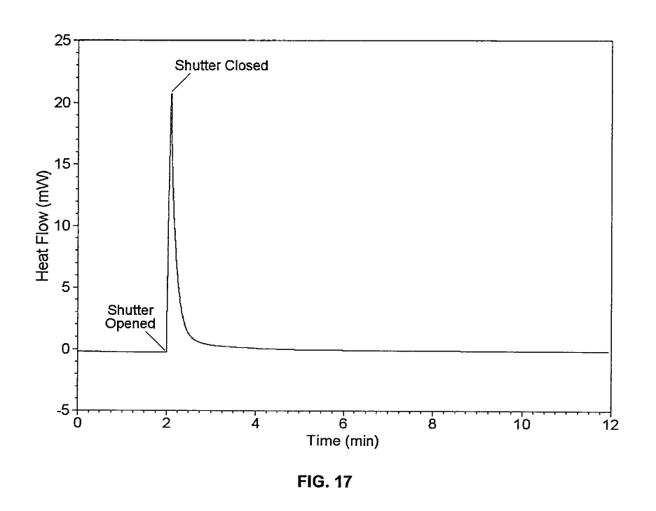

Reactions are carried out at various temperatures (−10, 25, and 60° C.) in order to establish an overall activation energy for polymerization. Reactions are also studied with various exposure times (1, 5, and 15 seconds) in order to observe any changes in the rate of polymerization. FIG. 17 is a typical exotherm obtained from the photo induced polymerizations.

The degree of cure, or conversion, can be estimated from the ratio of the amount of heat evolved from the partial conversion after time (t) at a specific temperature (Hₜ); to the total heat evolved from the reaction, ΔH_{P}:

α=(Hₜ/ΔHₚ)

If the above equation is a function of conversion, but not temperature; as in photo-induced experiments, the activation energy, E, can be obtained by plotting In[(1/ΔHₚ)(dH₀/dt)] versus (1/T), where (dH₀/dt) is the heat of polymerization at the maximum peak of the exotherm. Calculating the slope of this plot will yield the activation energy for the polymerization (see Table 2). Photo-DSC experiments record the total heat of polymerization; therefore, the activation energy is representative an overall activation energy which includes initiation, activation, and termination:

E_{R}=E_{P}+E_{I}−E_{T}

In order for the above equation to be valid, the production of active centers must remain throughout the reaction. Previous measurements analyzed the kinetic activity of photosensitizers and showed that the photosensitizers are not completely consumed until after the reaction has progressed. Indicating that the active center concentration continues to increase after the peak maximum, which is were the reaction rate is measured. As a result, the equation immediately above can be used to signify the overall activation energy for the photo-induced polymerization reaction. As anticipated, the reaction rate and total conversion increases with an increasing temperature. This is demonstrated from the exotherms exhibiting a larger integrated heat as the temperature is increased.

Increasing the size of the substituent has a dramatic effect on the rate of polymerization and total conversion (see Table 2). FIG. 19 also shows that as the size of the pendant group increases the glass transition temperature increases. The rates of polymerization are decreased by an overall average of 50% when comparing a methyl substituted to a cycloaliphatic substituted polysiloxane. This could be attributed to the large bulky substituents hindering molecular motion during the reaction and preventing the active species from further polymerization. As expected the longer exposure to UV light yields a higher conversion due to the production of more active species. The percent conversion calculation is taken from the moment the exotherm begins to the when the slope of the thermogram is equal to zero. The effects of post cure are not taken into account in the final calculation. The consequence of post cure would almost assuredly increase the final percent conversion value.

The activation energies for the cycloaliphatic substituted polysiloxanes are lower than the methyl substituted polysiloxane value. The higher average molecular weight (Mₙ) of the methyl substituted polysiloxane reduces the mobility of the epoxy groups, which leads to a higher activation energy. The dependence on activation energy with viscosity could also account for the slight difference in activation energy in the cycloaliphatic substituted polysiloxanes.

TABLE 2
Effect of Substituent and Temperature on the Rate of Polymerization

| | Mol. | | | Heat | | | |
|---|---|---|---|---|---|---|---|
| | Weight | | Exposure | Flow per | | Conversion | Activation |
| | (Mn- | Temp. | Time | Second | Rp | Percent. | Energy |
| Substituent | g/mol) | (° C.) | (sec) | (J/s) | (/s) | (%) | (kJ/mol) |
| Methyl | 45,500 | −10 | 5 | 9.456 | 0.0093 | 99.6 | 144.8 ± 8.1 |
| Methyl | 45,500 | 25 | 5 | 14.900 | 0.0110 | 99.5 | 144.8 ± 8.1 |
| Methyl | 45,500 | 60 | 5 | 19.646 | 0.0125 | 99.7 | 144.8 ± 8.1 |
| Cyclopentyl | 34,530 | −10 | 5 | 8.223 | 0.0025 | 90.4 | 111.0 ± 9.2 |
| Cyclopentyl | 34,530 | 25 | 5 | 5.892 | 0.0055 | 97.2 | 111.0 ± 9.2 |
| Cyclopentyl | 34,530 | 60 | 5 | 11.723 | 0.0057 | 97.4 | 111.0 ± 9.2 |
| Cyclohexyl | 38,290 | −10 | 5 | 8.113 | 0.0054 | 91.2 | 125.7 ± 8.5 |
| Cyclohexyl | 38,290 | 25 | 5 | 5.932 | 0.0047 | 96.7 | 125.7 ± 8.5 |
| Cyclohexyl | 38,290 | 60 | 5 | 16.890 | 0.0068 | 98.2 | 125.7 ± 8.5 |

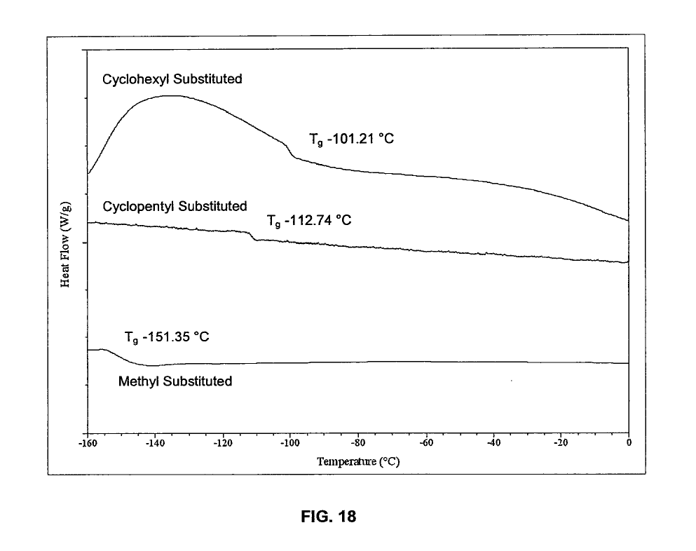

FIG. 18 illustrates that the glass transition temperature of the polysiloxanes disclosed herein can be tailored by the ability to add on the desired pendant group through hydrosilation. The pendant group could be chosen from a number of alkene functionalized systems.

The ability to synthesize polysiloxanes with cycloaliphatic pendant groups is beneficial in that it provides more monomers to be considered for new materials, membranes, films, or other potential applications. The capability to modify and/or tailor the pendant groups could potentially also solve miscibility and grafting issues by making the groups similar in structure and/or polarity to a specific type of solvent. Furthermore, tailoring the polysiloxanes with cycloaliphatic epoxides and alkoxy silane groups to UV curable hybrid films could potentially be used in the application towards membranes or low coefficient of friction coatings. The ability to adjust the glass transition temperature through the variation of the pendant groups is also be beneficial for other specialized applications such as lubricants for fibers, wetting agents for polyurethane foams, and temperature sensitive coagulating agents for latexes.

The need to understand and optimize curing conditions for inorganic/organic materials is critical for the in situ formation of nanocomposite materials. The rise in cationic curing chemistry is increasing due to the unique properties of ring-opening polymerization, which include inhibition of oxygen and the improved adhesion over free-radical UV-cured films. The PDSC experiments are used to determine the rate of polymerization and activation energies for the synthesized polysiloxanes in order to determine what effect the larger substituents have on the kinetics of polymerization in addition to temperature and UV-exposure time. The knowledge of cure kinetics and the ability to customize polysiloxanes unlocks new potential in the development of innovative polymers.

Accordingly, in one embodiment of the present invention a synthetic route is employed to prepare cationically polymerizable methyl, cyclopentyl, and cyclohexyl substituted polysiloxanes. The hydrosilation of internal alkenes is possible at high pressure and temperatures, but becomes sluggish when the silane functionality becomes sterically hindered, as seen in the hydrosilation between the cyclic oligomers and the cycloalkene. In addition, the ability to maintain the silane functionality throughout the hydrolytic polymerization makes it possible for additional hydrosilation between the polysiloxane chain and desired alkene. Analysis of the hydrolytic polymerization reaction shows the production of a wide range of cyclic oligomers, while the use of the sulfonated ion-exchange resin made the production of high molecular weight polysiloxanes particularly straightforward. Photo-DSC exotherms show that the bulky pendant groups affect the kinetics by lowering both the rate of polymerization and overall conversion, when compared to the methyl substituted polysiloxane. This is due to the bulky pendant groups interfering with molecular motion. As expected, the increase in UV-exposure time and reaction temperature results in an increase in the reaction rate for all of the substituted polysiloxanes. This increase yields higher final conversions as revealed from the total heat of the reaction.

Although the invention has been described in detail with particular reference to certain embodiments detailed herein, other embodiments can achieve the same results. Variations and modifications of the present invention will be obvious to those skilled in the art and the present invention is intended to cover in the appended claims all such modifications and equivalents.

What is claimed is:

1. A polysiloxane composition comprising:
a cyclic compound according to the following formula: 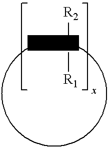
wherein x is an integer from 3 to 20, and R₁ and R₂ are independently selected from hydrogen, methyl, cyclopentyl, or cyclohexyl.

2. The polysiloxane composition of claim 1, wherein at least about 50 percent of the R₁s and R₂s are cyclopentyls or cyclohexyls.

3. The polysiloxane composition of claim 1, wherein at least about 50 percent of the R₁s and R₂s are hydrogens.

4. The polysiloxane composition of claim 1, wherein x is an integer from 3 to about 15.

5. The polysiloxane composition of claim 1, wherein x is an integer from about 6 to about 10.

6. The polysiloxane composition of claim 1, wherein x is equal to 8.

7. A polysiloxane composition comprising:
a linear compound according to the following formula: 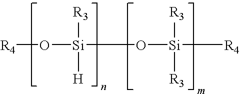
wherein the ratio of the n repeating units to m repeating units is from 1:1 to 1:64, and wherein each R₃ is independently selected from hydrogen, methyl, cyclopentyl, or cyclohexyl and each R₄ is independently selected from hydrogen and a cycloaliphatic epoxide.

8. The polysiloxane composition of claim 7, wherein the cycloaliphatic epoxide is:

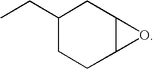

9. The polysiloxane composition of claim 6, wherein the cycloaliphatic epoxide links to the polysiloxane through the ethyl moiety of the cycloaliphatic epoxide.

10. A process for synthesizing a cyclic polysiloxane composition comprising the steps of:
(i) providing an effective amount of an aqueous base;
(ii) reacting a defined amount of cycloaliphatic dichlorosilane in the presence of the aqueous base; and
(iii) recovering the polysiloxane product.

11. The process of claim 10, wherein the defined amount of cycloaliphatic dichlorosilane is added dropwise to the effective amount of aqueous base.

12. The process of claim 10, wherein the aqueous base is saturated sodium bicarbonate.

13. The process of claim 10, wherein the cycloaliphatic dichlorosilane is dissolved in a nonpolar solvent.

14. The process of claim 13, wherein the nonpolar solvent is ether.

15. The process of claim 10, wherein the step of collecting further comprises one or more of precipitation, vacuum distillation, filtration or centrifugation.

16. The process of claim 10, wherein the cycloaliphatic dichlorosilane is selected from one or more of cyclohexyl dichlorosilane or cyclopentyl dichlorosilane.

17. The process of claim 15, wherein the reacting step occurs at a temperature from about 20° C. to about 30° C.

18. The process of claim 10, wherein the step of reacting further comprises reacting in the presence of a Karstedt's catalyst.

19. The process of claim 17, wherein the cycloaliphatic dichlorosilane is selected from one or more of dicyclohexyl dichlorosilane or dicyclopentyl dichlorosilane.

20. The process of claim 19, wherein the reacting step occurs at a temperature from about 100° C. to about 120° C.

21. A process for synthesizing linear polysiloxane comprising the steps of:
(a) providing a cyclic compound A comprising the following formula: 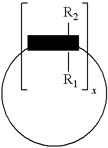
(b) providing a cyclic compound B comprising the following formula: 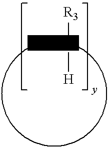
wherein R₁, R₂, and R₃ are independently selected from methyl, cyclopentyl, or cyclohexyl, and wherein x and y are independently integers from 3 to 20;
(c) combining cyclic compound A and cyclic compound B in the presence of an ion exchange resin;
(d) reacting cyclic compound A and cyclic compound B to form a linear compound according to the following formula: 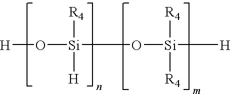
wherein each R₄ is independently selected from hydrogen, methyl, cyclohexyl or cyclopentyl; and
(e) recovering the linear compound.

22. The process of claim 21, wherein the linear compound recovered in Step (e) is further reacted in a process comprising the steps of:
(f) combining a first component comprising the linear compound from Step (e);
(g) combining a second component comprising a defined amount of a vinylcycloaliphaticepoxide;
(h) combining a third component comprising a defined amount of vinyl triethoxysilane;
(i) combining a fourth component comprising an effective amount of a catalyst;
(j) combining a fifth component comprising a defined amount of toluene, wherein the combination of the components from Steps (f), (g), (h), (i), and (j) yield a reaction mixture;
(k) heating the reaction mixture to a defined temperature;
(l) agitating the reaction mixture for a given period of time; and
(m) recovering a cycloaliphaticepoxide-terminated polysiloxane.

23. The process of claim 22, wherein the vinylcycloaliphaticepoxide is 4-vinyl-1-cyclohexene diepoxide.

24. The process of claim 22, wherein the catalyst is selected from one or more of Wilkinson's catalyst, Karstedt's catalyst, or Speier's catalyst.

25. The process of claim 21, wherein the defined temperature of Step (k) is between about 70° C. and about 80° C.
